(19) United States
(12) Patent Application Publication
(10) Pub. No.: US 2026/0223183 A1
(43) Pub. Date: Jul. 30, 2026

(54) DEVICE AND METHOD OF COMMUNICATION

(71) Applicant: NEC Corporation, Tokyo (JP)

(72) Inventors: Zonghui XIE, Beijing (CN); Lei CHEN, Beijing (CN); Gang WANG, Beijing (CN)

(73) Assignee: NEC Corporation, Tokyo (JP)

(21) Appl. No.: 19/143,608

(22) PCT Filed: Dec. 27, 2022
(86) PCT No.: PCT/CN2022/142549

§ 371 Date: Jun. 26, 2025

(51) Int. Cl. H04W 74/0833; H04W 48/20

(52) U.S. Cl. CPC H04W 74/0833; H04W 48/20

(57) ABSTRACT

Embodiments of the present disclosure relate to devices and methods of communication. In one aspect, a terminal device receives first information for selection of a target cell from at least one of an anchor cell or a set of non-anchor cells supporting NES, and receives second information for access to the set of non-anchor cells. The terminal device selects the target cell from the at least one of the anchor cell or the set of non-anchor cells based on the first information and the second information, and initiate an RA procedure to the target cell. In this way, an RA procedure related to a NES cell may be specified.

### TECHNICAL FIELD

Embodiments of the present disclosure generally relate to the field of telecommunication, and in particular, to devices and methods of communication for network energy saving (NES).

### BACKGROUND

For an objective of time and frequency domain network energy savings techniques, it is proposed to specify adaptation or reduction or elimination of common channels or signals in single or multi-carrier operation. In particular, random access (RA) related enhancement needs to be done on a synchronization signal and physical broadcast channel block (SSB)-less and/or system information block (SIB)-less NES cell. However, RA related to the NES cell is still unclear and needs to be further developed.

### SUMMARY

In general, embodiments of the present disclosure provide methods, devices and computer storage media of communication for RA related to a NES cell.

In a first aspect, there is provided a terminal device. The terminal device comprises a processor. The processor is configured to cause the terminal device to: receive first information for selection of a target cell from at least one of an anchor cell or a set of non-anchor cells, the set of non-anchor cells supporting network energy saving; receive second information for access to the set of non-anchor cells; select, based on the first information and the second information, the target cell from the at least one of the anchor cell or the set of non-anchor cells; and initiate a random access procedure to the target cell.

In a second aspect, there is provided a network device. The network device comprises a processor. The processor is configured to cause the network device to: transmit first information for selection of a target cell from at least one of an anchor cell or a set of non-anchor cells, the set of non-anchor cells supporting network energy saving; and transmit second information for access to the set of non-anchor cells, the first and second information being used for selection of the target cell for a random access procedure.

In a third aspect, there is provided a method of communication. The method comprises: receiving, at a terminal device, first information for selection of a target cell from at least one of an anchor cell or a set of non-anchor cells, the set of non-anchor cells supporting network energy saving; receiving second information for access to the set of non-anchor cells; selecting, based on the first information and the second information, the target cell from the at least one of the anchor cell or the set of non-anchor cells; and initiating a random access procedure to the target cell.

In a fourth aspect, there is provided a method of communication. The method comprises: transmitting, at a network device, first information for selection of a target cell from at least one of an anchor cell or a set of non-anchor cells, the set of non-anchor cells supporting network energy saving; and transmitting second information for access to the set of non-anchor cells, the first and second information being used for selection of the target cell for a random access procedure.

In a fifth aspect, there is provided a computer readable medium having instructions stored thereon. The instructions, when executed on at least one processor, cause the at least one processor to perform the method according to the third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a process of communication according to embodiments of the present disclosure;

FIG. 3 illustrates an example method of communication implemented at a terminal device in accordance with some embodiments of the present disclosure;

FIG. 4 illustrates an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal s device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “anchor cell” may refer to a cell where UE is capable of receiving SSB, SIB and paging. The term “non-anchor cell” may refer to a cell where UE cannot receive at least one of SSB or SIB. The term “non-anchor cell” may be interchangeably used with “non-anchor NES cell”, “NES cell”, “SSB-less cell”, “SIB-less cell”, “SSB-less and/or SIB-less cell”, “SIBI-less cell” or “SSB-less and/or SIBI-less cell”.

As mentioned above, RA related to a NES cell is still unclear. For example, in case of UE accessing cells with NES technologies, it is still not specified how to determine to which cell the RA should be initiated.

In view of this, embodiments of the present disclosure provide a solution of communication for RA related to a NES cell. In the solution, a terminal device receives first information for selection of a target cell from at least one of an anchor cell or a set of non-anchor cells and second information for access to the set of non-anchor cells. Based on the first and second information, the terminal device selects the target cell from the at least one of the anchor cell or the set of non-anchor cells. Then the terminal device initiates an RA procedure to the target cell. In this way, an RA procedure related to a NES cell may be specified.

Principles and implementations of the present disclosure will be described in detail below with reference to the figures.

### Example of Communication Network

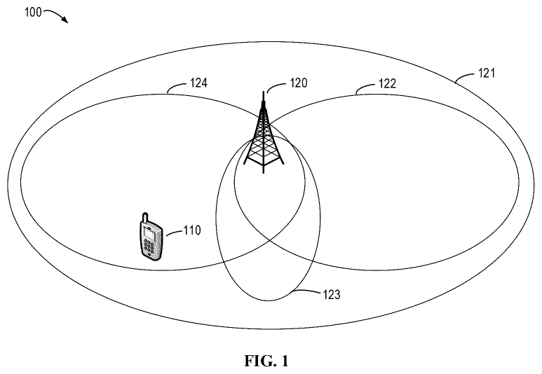

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a plurality of serving cells (also referred to as cells herein) 121, 122, 123 and 124 to serve one or more terminal devices.

In this example, the terminal device 110 may be served by the cells 121, 122, 123 and 124. The cell 121 may serve as an anchor cell where the terminal device 110 can receive SSB, SIB and paging. The cells 122, 123 and 124 may serve as non-anchor cells where the terminal device 110 cannot receive at least one of SSB or SIB.

It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 110 may initiate an RA procedure, e.g., when the terminal device 110 is to enter a connected state from an idle or inactive state.

However, it is unclear which cell in the cells 121, 122, 123 and 124 is used for the RA procedure.

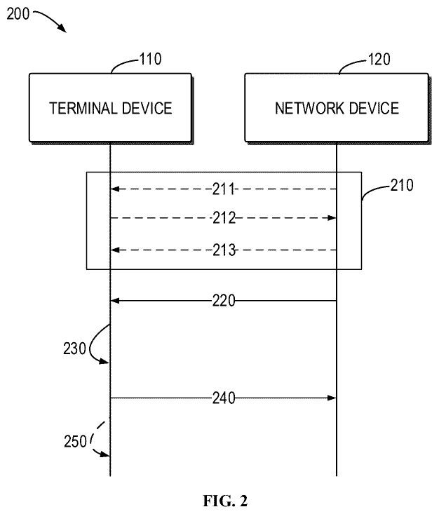

Embodiments of the present disclosure provide a solution of initiating an RA procedure so as to overcome the above and other potential issues. The detailed description will be made with reference to FIG. 2 below.

### Example Implementation of RA Procedure

FIG. 2 illustrates a schematic diagram illustrating a process 200 of communication according to embodiments of the present disclosure. For the purpose of discussion, the process 200 will be described with reference to FIG. 1. The process 200 may involve the terminal device 110 and the network device 120 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added. In this example, the cell 121 serves as an anchor cell, and the cells 122, 123 and 124 serves as non-anchor NES cells.

As shown in FIG. 2, the network device 120 may transmit 210, to the terminal device 110, information (for convenience, also referred to as first information herein) for selection of a target cell. In some embodiments, the target cell may be selected from a set of non-anchor cells (e.g., the cell 122, 123 and 124). In some embodiments, the target cell may be selected from an anchor cell and a set of non-anchor cells (e.g., the cell, 121, 122, 123 and 124).

With reference to FIG. 2, in some embodiments, the network device 120 may configure 211 the first information in system information.

In some embodiments, the first information may comprise a criterion for selection of the target cell. In some embodiments, the criterion may be based on a probability of selecting the anchor cell. In some embodiments, the criterion may be based on a probability or a probability list of selecting a non-anchor cell (e.g., each non-anchor cell) in the set of non-anchor cells. In some embodiments, the criterion may be based on a weight or a weight list of anon-anchor cell (e.g., each non-anchor cell) in the set of non-anchor cells. In some embodiments, the criterion may be based on a weight of the anchor cell and a weight list of a non-anchor cell (e.g., each non-anchor cell) in the set of non-anchor cells. In some embodiments, the criterion may be based on a RACH indication partition (RIP) feature. In some embodiments, the criterion may be based on threshold quality for cells.

In some alternative embodiments, the first information may comprise a set of criteria for selection of the target cell. Criteria in the set of criteria may be associated with radio conditions (i.e., coverage level, serving quality) of the anchor cell for the terminal device 110. In other words, different criteria in the set of criteria may be applied in different radio conditions of the anchor cell for the terminal device 110. Alternatively, criteria in the set of criteria may be associated with SSBs from the anchor cell. In other words, different criteria in the set of criteria may be applied for terminal device 110 served by different SSBs from the anchor cell.

In some embodiments, the set of criteria may be based on a probability of selecting the anchor cell. For example, the set of criteria may comprise a set of probabilities of selecting the anchor cell. In some embodiments, the set of criteria may be based on a probability of selecting a non-anchor cell. For example, the set of criteria may comprise a set of probabilities of selecting the non-anchor cell. In some embodiments, the set of criteria may be based on a weight of an anchor cell and a weight of anon-anchor cell. For example, the set of criteria may comprise a set of weight lists and each weight list in the set comprises a weight of an anchor cell and a weight of each non-anchor cell. In some embodiments, the set of criteria may be based on a weight of a non-anchor cell. For example, the set of criteria may comprise a set of weight lists and each weight list in the set comprises a weight of each non-anchor cell. In some embodiments, the set of criteria may be based on a RIP feature. In some embodiments, the RIP feature may comprise reduced capability (RedCap), small data transmission (SDT), network slice access stratum group (NSAG), or Msg3 repetition. For example, criteria in the set of criteria may comprise different RIP features. In some embodiments, the set of criteria may be based on threshold quality for cells. For example, the set of criteria may comprise a set of threshold quality.

Continue to refer to FIG. 2, in some alternative embodiments, the terminal device 110 may indicate 212 supporting of access to a non-anchor cell during a connected state. The network device 120 may transmit 213 a dedicated signaling comprising the first information.

In some embodiments, the network device 120 may transmit a radio resource control (RRC) message comprising the first information. In these embodiments, the first information comprises information of a non-anchor cell as the target cell. In some embodiments, the RRC message may comprise a RRC release message or any other suitable messages.

In some embodiments, the network device 120 may transmit downlink control information (DCI) comprising the first information. For example, if an RA procedure is initiated by a PDCCH order, information of the target cell for the terminal device 110 may be comprised in the DCI. In some embodiments, the first information may comprise information of a non-anchor cell as the target cell. In some embodiments, the DCI may comprise an identity (ID) of the target cell. In some embodiments, if the information of the non-anchor cell is absent in the DCI, the RA procedure may be initiated towards an anchor cell.

In some additional embodiments, the DCI may comprise an index of SSB for determination of an occasion for initiating the RA procedure in the non-anchor cell. For example, the index may comprise 6 bits. If a value of a field “Random Access Preamble index” is not all zeros, this field indicates the SSB that shall be used to determine the RACH occasion for a physical random access channel (PRACH) transmission. If the non-anchor cell as the target cell is indicated, this field indicates the SSB of the anchor cell that shall be used to determine the RACH occasion for the PRACH transmission in the non-anchor cell. Otherwise, this field is reserved. In some embodiments, the network device 120 may transmit, to the terminal device 110, a mapping between SSBs of the anchor cell and occasions for RA to the non-anchor cell. In this way, an occasion for initiating an RA procedure in a non-anchor cell may be determined.

Continue to refer to FIG. 2, the network device 120 may also transmit 220, to the terminal device 110, information (for convenience, also referred to as second information herein) for access to the set of non-anchor cells. In some embodiments, the network device 120 may transmit, via the anchor cell, system information comprising the second information for access to anon-anchor cell (e.g., each non-anchor cell) in the set of non-anchor cells. In this way, the terminal device 110 may obtain a configuration for access to each non-anchor cell.

In some embodiments for a non-anchor cell RACH configuration, a SIB may carry non-anchor cell RACH information. For example, an IE SystemInformationBlockTypeXX may comprise a radio resource configuration for an RA procedure on non-anchor cells.

In some embodiments for a non-anchor cell RACH configuration, selecting criteria parameters may be coverage specific. For example, the network device 120 may broadcast N sets of selecting criteria, and each set may be associated with an anchor cell quality range. In some embodiments for a non-anchor cell RACH configuration, selecting criteria parameters may be SSB specific. For example, the network device 120 may broadcast N sets of selecting criteria, and each set may be associated with at least one SSB.

In some embodiments, the second information may comprise cell status information indicating availability of a non-anchor cell in the set of non-anchor cells for RA. In some embodiments, the cell status information may comprise a bitmap indicating the availability of the non-anchor cell in the set of non-anchor cells. For example, the bitmap indicates {1, 1, 0}. That is, non-anchor cells 122 and 123 may be considered during the selection of the target cell, and non-anchor cell 124 may be shut down or sleep or deactivated using other NES technologies.

In some embodiments, the cell status information may be coverage specific. For example, different sets of cell status information may be provided for terminal devices with measured anchor cell quality within different quality ranges.

In some embodiments, the cell status information may be SSB specific. For example, different sets of cell status information may be provided for the terminal device 110 served by different SSBs. The terminal device 110 may determine the best quality SSB according to anchor cell measurement results, and use a set of cell status information associated with the best quality SSB.

For illustration, an example configuration for cell status information may be described as below.

| | |
|---|---|
| SystemInformationBlockTypeXX ::= | SEQUENCE { |
| cellStatusList | CellStatusList, |
| CellStatusList | SEQUENCE (SIZE (1...maxNroNonAnchor)) OF CellStatus |
| CellStatus | SEQUENCE { |
| cellAvailability | ENUMERATED {true} |
| ssbOrSIBLess | ENUMERATED {without SIB, without SSB and SIB} |

...
}
}

In some embodiments, the second information may further comprise an indication indicating whether the non-anchor cell does not transmit a SIB or whether the non-anchor cell does not transmit a SIB and a SSB.

With the cell status information, it is unnecessary to update anon-anchor cell uplink configuration every time when status of the non-anchor cell changes.

Continue to refer to FIG. 2, based on the first and second information, the terminal device 110 may select 230 the target cell from candidate cells. In some embodiments, the candidate cells may comprise the set of non-anchor cells. In some embodiments, the is candidate cells may comprise the set of non-anchor cells and the anchor cell. In some embodiments, the candidate cells may be overlapped with each other. In some embodiments, the candidate cells may be not overlapped with each other. For illustration, some example embodiments for the selection of the target cell will be described below in connection with Embodiments 1 to 12.

### Embodiment 1

In this embodiment, a configuration indicating a probability of selecting an anchor cell is received as the first information.

In some embodiments, the terminal device 110 may determine a probability of selecting a non-anchor cell in the set of non-anchor cells based on the probability of selecting the anchor cell and a number of available non-anchor cells. For example, the terminal device 110 may determine the probability of selecting the non-anchor cell based on equation (1) below.

$$P\_non - anchor = ( 1 - P - anchor ) / N \qquad ( 1 )$$

where P_non-anchor denotes a probability of selecting a non-anchor cell, P_anchor denotes a probability of selecting an anchor cell, and N denotes a number of available non-anchor cells.

Based on the probability of selecting the anchor cell and the probability of selecting the non-anchor cell, the terminal device 110 may select the target cell from the anchor cell and the set of non-anchor cells.

In this way, a network may achieve load control of candidate cells with a configured probability of selecting an anchor cell.

### Embodiment 2

In this embodiment, a configuration indicating a probability of selecting an anchor cell and a set of probabilities of selecting a non-anchor cell in the set of non-anchor cells is received as the first information.

In some embodiments, the terminal device 110 may select the target cell from the anchor cell and the set of non-anchor cells based on the probability for the anchor cell and the set of probabilities for each non-anchor cell.

In this way, a network may achieve load control of candidate cells with a configured probability of selecting an anchor cell and a configured probability of selecting a non-anchor cell.

### Embodiment 3

In this embodiment, a configuration indicating a weight of an anchor cell and a set of weights of non-anchor cells in the set of non-anchor cells is received as the first information.

In some embodiments, the terminal device 110 may select the target cell from the anchor cell and the set of non-anchor cells based on the weights for the anchor cell and the set of non-anchor cells. For example, the target cell may be determined by a cell with smallest index n (0≤n≤Nn−1) fulfilling equation (2) below:

$$UE\_ID mod W < W ( 0 ) + W ( 1 ) + … + W ( n ) \qquad ( 2 )$$

where UE_ID denotes an ID of the terminal device 110, W(i) denotes a weight of the non-anchor cell i, and W denotes a sum of configured weights of all cells, i.e., W=W(0)+W(1)+ . . . +W(Nn−1), where Nn denotes a total number of candidate cells.

In another example, the target cell may be determined by a cell with smallest index n (0≤n≤Nn−1) fulfilling equation (3) below:

$$Floor ( UE\_ID / X ) mod W < W ( 0 ) + W ( 1 ) + … + W ( n ) \qquad ( 3 )$$

where UE_ID denotes an ID of the terminal device 110, X is a pre-defined integer, W(i) denotes a weight of the non-anchor cell i, and W denotes a sum of configured weights of all cells, i.e., W=W(0)+W(1)+ . . . +W(Nn−1), where Nn denotes a total number of candidate cells.

In this way, a network may achieve load control of candidate cells with configured weights for an anchor cell and a non-anchor cell.

### Embodiment 4

In this embodiment, a configuration indicating threshold quality (for convenience, also referred to as first threshold quality herein) for cells is received as the first information.

In some embodiments, the terminal device 110 may determine cell quality of the anchor cell and cell quality of each non-anchor cell. In some embodiments, the terminal device 110 may determine the cell quality of the anchor cell by measuring a set of reference signals from the anchor cell. In some embodiments, the terminal device 110 may determine the cell quality of a non-anchor cell by measuring a set of reference signals from the non-anchor cell (i.e., SSB, channel state information reference signal (CSI-RS) or other reference signals). In some embodiments, the terminal device 110 may estimate the cell quality of a non-anchor cell from the cell quality of the anchor cell.

In some embodiments, the terminal device 110 may receive, from the network device 120, a configuration indicating a set of offsets associated with the set of non-anchor cells. Then the terminal device 110 may determine cell quality of a non-anchor cell based on an offset associated with the non-anchor cell in the set of offsets and the cell quality of the anchor cell. In this way, cell quality of a non-anchor cell may be determined.

In some embodiments, the terminal device 110 may receive, from the network device 120, a configuration indicating a mapping between the set of non-anchor cells and SSBs of the anchor cell. An example mapping is shown in Table 1 below. It is to be understood that Table 1 is merely for illustration, and is not intended for limitation.

TABLE 1

| | |
|---|---|
| Non-anchor cell 122 | SSB-Index = 1, 2 |
| Non-anchor cell 123 | SSB-Index = 2, 3, 4, 5 |
| Non-anchor cell 124 | SSB-Index = 5, 6 |

For example, an example configuration of the mapping may be described as below.

nonAnchorToAnchorQualityMapping::=SEQUENCE (SIZE (1...maxNrofNonAnchorCel))
OF SSB-IndexList
ssb-IndexList ::= SEQUENCE (SIZE (1... maxNrofSSBs)) OF SSB-Index

In another example, an example configuration of the mapping may be described as below.

NonAnchorToAnchorQualityMapping::=SEQUENCE{

| | |
|---|---|
| cellIdentity | CellIdentity, |
| ssb-IndexList | SEQUENCE (SIZE (1... maxNrofSSBs)) OF SSB-Index |

}

In still another example, an example configuration of the mapping may be described as below.

| NonAnchorToAnchorQualityMapping::=SEQUENCE{ | |
|---|---|
| cellIdentity | CellIdentity, |
| mappingSSBs | CHOICE{ |
| allSSBs | Null |
| ssb-IndexList | SEQUENCE (SIZE (1... maxNrofSSBs)) OF |
| | SSB-Index |

}
}

Based on the mapping, the terminal device 110 may determine a set of SSBs (i.e., one or more SSBs) corresponding to a non-anchor cell. Then the terminal device 110 may determine a set of beam measurement results of the set of SSBs. Based on the set of beam measurement results, the terminal device 110 may determine cell quality of the non-anchor cell.

In some embodiments, the terminal device 110 may determine, as the cell quality of the non-anchor cell, the highest beam measurement result in the set of beam measurement results. In some embodiments, the terminal device 110 may determine, as the cell quality of the non-anchor cell, an average value (e.g., a linear power scale average) of the set of beam measurement results.

In some embodiments, if the highest beam measurement result in the set of beam measurement results is below (e.g., lower than or equal to) a threshold measurement result or the threshold measurement result is not configured, the terminal device 110 may determine the cell quality of the non-anchor cell based on the highest beam measurement result. In some embodiments, if the threshold measurement result is configured and the highest beam measurement result in the set of beam measurement results is above (e.g., higher than or equal to) the threshold measurement result, the terminal device 110 may determine the cell quality of the non-anchor cell based on an average value of the set of beam measurement results.

For example, an example procedure may be described as below.
If absThreshSS-BlocksConsolidation-NES is not configured or the highest beam measurement quantity value is below or equal to absThreshSS-BlocksConsolidation-NES: derive each non-anchor cell measurement quantity based on the corresponding anchor cell SS/PBCH block(s) as the highest beam measurement quantity value;
else: derive each non-anchor cell measurement quantity based on the corresponding anchor cell SS/PBCH block(s) as the linear power scale average of the highest beam measurement quantity values above absThreshSS-BlocksConsolidation-NES where the total number of averaged beams shall not exceed nrofSS-BlocksToAverage-NES.

Upon determination of the cell quality of the anchor cell and the set of non-anchor cells, the terminal device 110 may select the target cell from the anchor cell and the set of non-anchor cells based on the first threshold quality and the cell quality of the anchor cell and the set of non-anchor cells.

In some embodiments, the terminal device 110 may determine, from the anchor cell and the set of non-anchor cells, a set of cells having cell quality above the first threshold quality. For example, the terminal device 110 may determine a set of cells having the highest cell quality. If the set of cells comprises a single cell, the terminal device 110 may determine the single cell as the target cell. In some embodiments, if the set of cells comprises a plurality of cells, the terminal device 110 may select the target cell from the plurality of cells based on a criterion. In some embodiments, the terminal device 110 may receive a configuration indicating the criterion. In some embodiments, the criterion may be based on a probability of selecting each cell in the anchor cell and the set of non-anchor cells. In some embodiments, the criterion may be based on a weight of each cell. The selection of the target cell based on the criterion may be carried out in similar way as that described in Embodiments 1 to 3, and thus other details are omitted for concise.

In this way, a terminal device may determine a cell with good quality to access.

### Embodiment 5

In this embodiment, a configuration indicating threshold quality (for convenience, also referred to as second threshold quality herein) for non-anchor cells is received as the first information.

In some embodiments, the terminal device 110 may determine cell quality of each non-anchor cell in the set of non-anchor cells, and select the target cell from the set of non-anchor cells based on the second threshold quality and the cell quality of the set of non-anchor cells.

In some embodiments, the terminal device 110 may determine, from the set of non-anchor cells, a set of cells having cell quality above the second threshold quality. For example, the terminal device 110 may determine a set of cells having the highest cell quality. If the set of cells comprises a single cell, the terminal device 110 may determine the single cell as the target cell. In some embodiments, if the set of cells comprises a plurality of cells, the terminal device 110 may select the target cell from the plurality of cells based on a criterion. In some embodiments, the terminal device 110 may receive a configuration indicating the criterion. In some embodiments, the criterion may be based on a probability of selecting each cell in the set of non-anchor cells. In some embodiments, the criterion may be based on a weight of each cell in the set of non-anchor cells. The selection of the target cell based on the criterion may be carried out in similar way as that described in Embodiments 1 to 3, and thus other details are omitted for concise.

In this way, a terminal device may determine a non-anchor cell with good quality to access.

### Embodiment 6

In this embodiment, a configuration indicating a mapping between the set of non-anchor cells and indexes of SSBs of the anchor cell is received as the first information. The configuration of the mapping may be carried out in a similar way as that described in Embodiment 4, and thus its details are not repeated here for concise.

In some embodiments, the terminal device 110 may determine an SSB of the anchor cell having the highest beam measurement result among a set of SSBs of the anchor cell. Based on the SSB, the terminal device 110 may determine, from the mapping, a set of non-anchor cells associated with the SSB.

If the set of non-anchor cells comprises a single cell, the terminal device 110 may determine the single cell as the target cell. If the set of non-anchor cells comprises a plurality of non-anchor cells, the terminal device 110 may determine a non-anchor cell from the plurality of non-anchor cells based on a criterion.

In some embodiments, the terminal device 110 may receive a configuration indicating the criterion. In some embodiments, the criterion may be based on a probability of selecting each cell in the set of non-anchor cells. In some embodiments, the criterion may be based on a weight of each cell in the set of non-anchor cells. The selection of the target cell based on the criterion may be carried out in similar way as that described in Embodiments 1 to 3, and thus other details are omitted for concise.

In this way, a terminal device may determine a non-anchor cell with good quality to access.

### Embodiment 7

In this embodiment, the terminal device 110 may receive, as the first information, an indication indicating that an RIP feature is used as a criterion for the selection of the target cell and the terminal device 110 may determine that the RIP feature is applicable for the current RA procedure.

In the context of the present disclosure, if this is the Random Access procedure for which RedCap indication is applicable, the RedCap feature is applicable for the current RA procedure. If the Random Access procedure is triggered for SDT, the SDT feature is applicable for the current RA procedure. If the Random Access procedure is triggered for the corresponding NSAG indication, the NSAG feature is applicable for the current RA procedure. If the reference signal receiving power (RSRP) of an anchor cell downlink pathloss reference is less than a predetermined threshold (e.g., rsrp-ThresholdMsg3), the msg3 repetition is applicable for the current RA procedure.

In some embodiments, the terminal device 110 may identify, from the anchor cell and the set of non-anchor cells, a cell having a RACH resource configured with the RIP feature. If a single cell is identified, the terminal device 110 may select the single cell as the target cell. If a plurality of cells are identified, the terminal device 110 may select the target cell from the plurality of cells based on a criterion.

In some embodiments, the terminal device 110 may receive a configuration indicating the criterion. In some embodiments, the criterion may be based on a probability of selecting each cell in the anchor cell and the set of non-anchor cells. In some embodiments, the criterion may be based on a weight of each cell in the anchor cell and the set of non-anchor cells. The selection of the target cell based on the criterion may be carried out in similar way as that described in Embodiments 1 to 3, and thus other details are omitted for concise.

In this way, a terminal device may determine a cell with an expected RIP feature to access.

### Embodiment 8

In this embodiment, the terminal device 110 may also receive, as the first information, an indication indicating that a RIP feature is used as a criterion for the selection of the target cell and is applicable for the RA procedure.

In some embodiments, the terminal device 110 may determine a set of cells having a quality higher than a configured threshold quality. If a RACH resource for a single cell in the set of cells is configured with the RIP feature, the terminal device 110 may select the single cell as the target cell. If RACH resources for a plurality of cells in the set of cells are configured with the RIP feature, the terminal device 110 may select the target cell from the plurality of cells based on a criterion.

In some embodiments, the terminal device 110 may receive a configuration indicating the criterion. In some embodiments, the criterion may be based on a probability of selecting each cell in the anchor cell and the set of non-anchor cells. In some embodiments, the criterion may be based on a weight of each cell in the anchor cell and the set of non-anchor cells. The selection of the target cell based on the criterion may be carried out in similar way as that described in Embodiments 1 to 3, and thus other details are omitted for concise.

In this way, a terminal device may determine a cell with an expected RIP feature to access.

### Embodiment 9

In this embodiment, a set of criteria for the selection of the target cell is received as the first information. Criteria in the set of criteria are associated with radio conditions (i.e., coverage level or serving quality) of the anchor cell for the terminal device 110.

In some embodiments, the terminal device 110 may determine a radio condition of the anchor cell for the terminal device 110 by a signal quality measurement for the anchor cell. The terminal device 110 may determine, from the set of criteria, a criterion associated with the radio condition, and select, based on the criterion, the target cell from the anchor cell and the set of non-anchor cells. The selection of the target cell based on the criterion may be carried out in similar way as that described in Embodiments 1 to 8, and thus other details are omitted for concise.

For example, an example configuration for a probability of an anchor cell may be described as below.

| | |
|---|---|
| SystemInformationBlockTypeXX ::= | SEQUENCE { |
| criteriaSetList | CriteriaSetList, |
| criteriaSetList | SEQUENCE (SIZE (1...maxNroCriteriaSet)) OF |

probabilityAnchor,

| | |
|---|---|
| probabilityAnchor | ENUMERATED {zero, oneSixteenth, oneFifteenth, |

oneFourteenth, oneThirteenth, oneTwelfth, oneEleventh, oneTenth, oneNinth, oneEighth,
oneSeventh, oneSixth, oneFifth, oneFourth, oneThird, oneHalf}
...
}

In another example, an example configuration for a weight list of cells may be described as below.

| | |
|---|---|
| SystemInformationBlockTypeXX ::= | SEQUENCE { |
| criteriaSetList | CriteriaSetList, |
| CriteriaSetList | SEQUENCE (SIZE (1...maxNroCriteriaSet)) OF CriteriaSet, |
| CriteriaSet | SEQUENCE { |
| ProbabilityList | SEQUENCE (SIZE (1...maxNroCandidateCells)) OF Probability, |

}
ENUMERATED {w1, w2, w3, w4, w5, w6, w7, w8, w9, w10, w11, w12, w13, w14, w15,
w16}
...
}

In these examples, if maxNroCriteriaSet=2, the configuration in the first entry of criteriaSetList is used by a terminal device with anchor cell measured RSRP above a threshold, and the configuration in the second entry of criteriaSetList is used by a terminal device with anchor cell measured RSRP below the threshold.

In this way, a terminal device with good coverage and a terminal device with bad coverage may be differentially assigned to candidate cells for RA.

### Embodiment 10

In this embodiment, a set of criteria for the selection of the target cell is received as the first information. Criteria in the set of criteria are associated with SSBs from the anchor cell.

In some embodiments, the terminal device 110 may determine a set of SSBs from the anchor cell that have signal quality above threshold signal quality. The terminal device 110 may determine, from the set of criteria, a criterion associated with the set of SSBs. For example, the terminal device 110 may determine a SSB that has the highest signal quality, and determine a criterion associated with the SSB in the set of criteria.

Based on the determined criterion, the terminal device 110 may select the target cell from the anchor cell and the set of non-anchor cells. The selection of the target cell based on the criterion may be carried out in similar way as that described in Embodiments 1 to 8, and thus other details are omitted for concise.

In some embodiments, multiple SSBs may be associated with the same criteria set. For example, an example configuration for criteria may be described as below.

| | |
|---|---|
| SystemInformationBlockTypeXX ::= | SEQUENCE { |
| criteriaSetList | CriteriaSetList, |
| criteriaSetList | SEQUENCE (SIZE (1...maxNroCriteriaSet)) OF CriteriaSet, |
| CriteriaSet | SEQUENCE { |
| associateSSBs | SEQUENCE (SIZE (1...maxNrofSSBs)) OF SSB-index, |
| weightList | SEQUENCE (SIZE (1...maxNroCandidateCells)) OF Weight, |

}

| | |
|---|---|
| Weight | ENUMERATED {w1, w2, w3, w4, w5, w6, w7, w8, w9, w10, w11, w12, w13, |

w14, w15, w16}
...
}

In this way, terminal devices may be differentially assigned to candidate cells according to locations of terminal devices to initiate RA.

### Embodiment 11

In this embodiment, the terminal device 110 receives a RRC message comprising information of anon-anchor cell as the target cell. In this case, the terminal device 110 may determine the indicated non-anchor cell as the target cell.

In some embodiments, the terminal device 110 may obtain information to access the indicated non-anchor cell from broadcast signaling of the network device 120. If the RRC message (e.g., RRC release message) comprises an indication (e.g., redirectedCarrierInfo) indicating redirection to the non-anchor cell, the terminal device 110 may initiate RA to the indicated non-anchor cell based on the broadcasting information for access the non-anchor cell.

In some embodiments, if a change of a cell quality measurement result is above (e.g., higher than or equal to) a threshold change or a cell reselection occurs, the terminal device 110 may consider the information of the non-anchor cell to be invalid. In other words, if the terminal device 110 moves (measured anchor cell quality has increased/decreased by more than a threshold quality) or cell reselection occurs, the indicated non-anchor cell as the target cell will no longer be valid.

In this way, a terminal device may be assigned to an indicated candidate cell for RA by a RRC message.

### Embodiment 12

In this embodiment, the terminal device 110 receives DCI comprising information of a non-anchor cell as the target cell. In this case, the terminal device 110 may determine the indicated non-anchor cell as the target cell.

In some embodiments, the terminal device 110 may obtain information to access the indicated non-anchor cell from broadcast signaling of the network device 120. If the DCI comprises an ID of the non-anchor cell, the terminal device 110 may initiate RA to the indicated non-anchor cell based on the broadcasting information for access the non-anchor cell.

In this way, a terminal device may be assigned to an indicated candidate cell for RA by DCI.

Continue to refer to FIG. 2, upon determination of the target cell, the terminal device 110 may initiate 240 an RA procedure to the target cell.

In some embodiments where DCI comprising information of a non-anchor cell as the target cell is received, the DCI may comprise an index of SSB. The terminal device 110 may determine an occasion for initiating the RA procedure in the non-anchor cell. The terminal device 110 may receive a mapping between SSBs of the anchor cell and occasions for RA to the non-anchor cell, and determine the occasion for initiating the RA procedure based on the mapping and the index of the SSB indicated in the DCI.

In some embodiments, the terminal device 110 may receive a mapping between SSBs of the anchor cell and occasions for RA to a non-anchor cell in the set of non-anchor cells. If a SSB of the anchor cell is selected, the terminal device 110 may determine an occasion for initiating the RA procedure in the non-anchor cell based on the mapping and the selected SSB. In other words, a SSB of an anchor cell may be used to determine an RACH occasion for a PRACH transmission in a non-anchor cell.

For illustration, an example procedure may be described as below.

1> for the contention-based Random Access preamble selection:

2> if at least one of the SSBs of anchor cell with SS-RSRP above rsrp-ThresholdSSB is

available:

3> select an SSB of anchor cell with SS-RSRP above rsrp-ThresholdSSB.

2> else:

3> select any SSB of anchor cell.

...

1> else if an SSB of anchor cell is selected above:

2> determine the next available PRACH occasion from the PRACH occasions of non-

anchor cell corresponding to the selected SSB permitted by the restrictions given by the ra-
ssb-OccasionMaskIndex if configured or indicated by PDCCH.

Continue to refer to FIG. 2, if the RA procedure may be unsuccessfully completed, the terminal device 110 may perform a cell re-determination procedure to determine 250 a further cell for RA. In some embodiments, the terminal device 110 may receive, from the network device 120, a configuration indicating a backoff offset. Based on the target cell and the backoff offset, the terminal device 110 may determine the further cell for RA. Thus, this will temporarily avoid reselecting the previous cell.

For example, an example procedure may be described as below.

If the RA procedure is not completed, the terminal device 110 may select a random backoff time according to a uniform distribution between 0 and the PREAMBLE_BACKOFF. If the RA procedure is an NES RA and a backoff offset is configured, the terminal device 110 may perform the cell re-determination procedure using the backoffOffset after the backoff time.

In some embodiments, the backoff offset may be a quality offset. For example, when the terminal device 110 does cell quality ranking during the cell re-determination procedure, the terminal device may use the backoff offset to adjust the weight or probability offset. For example, when the terminal device 110 re-determines the further cell for RA, the terminal device 110 may use the backoff offset to adjust the probability or weight of the cell to which an uncompleted RA was just initiated.

In some embodiments, the terminal device 110 may receive a configuration indicating valid information of the backoff offset. The terminal device 110 may apply the backoff offset based on the valid information. In this way, the further cell may be determined efficiently.

In some embodiments, the valid information may comprise a valid duration of the backoff offset. The terminal device 110 may apply the backoff offset when a timer with a length equal to the valid duration is running. In some embodiments, the valid information may comprise valid attempts of the backoff offset. The terminal device 110 may apply the backoff offset before the number of re-determining attempts exceeds a configured value.

With the process 200, an RA procedure related to a NES cell may be specified.

### Example Implementation of Methods

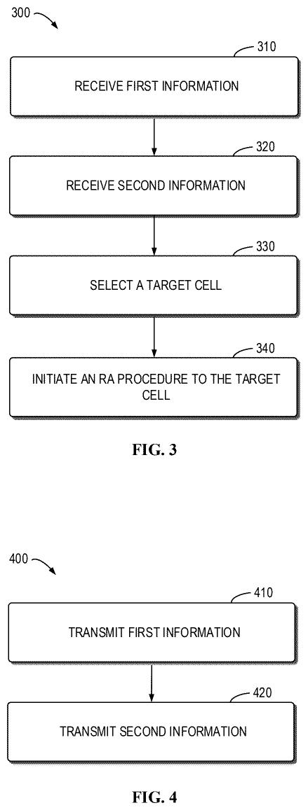

Corresponding to the above processes, embodiments of the present disclosure provide methods of communication implemented at a terminal device and a network device. These methods will be described below with reference to FIGS. 3 to 4.

FIG. 3 illustrates an example method 300 of communication implemented at a terminal device in accordance with some embodiments of the present disclosure. For example, the method 300 may be performed at the terminal device 110 as shown in FIG. 1. For the purpose of discussion, in the following, the method 300 will be described with reference to FIG. 1. It is to be understood that the method 300 may include additional blocks not shown and/or may omit some blocks as shown, and the scope of the present disclosure is not limited in this regard.

At block 310, the terminal device 110 receives first information for selection of a target cell from at least one of an anchor cell or a set of non-anchor cells. The set of non-anchor cells supports NES.

At block 320, the terminal device 110 receives second information for access to the set of non-anchor cells.

At block 330, the terminal device 110 selects, based on the first information and the second information, the target cell from the at least one of the anchor cell or the set of non-anchor cells.

In some embodiments, the terminal device 110 may receive the first information by receiving a configuration indicating a probability of selecting the anchor cell. In these embodiments, the terminal device 110 may select the target cell by: determining, based on the probability of selecting the anchor cell and a number of available non-anchor cells, a probability of selecting a non-anchor cell in the set of non-anchor cells; and selecting the target cell from the anchor cell and the set of non-anchor cells based on the probability of selecting the anchor cell and the probability of selecting the non-anchor cell.

In some embodiments, the terminal device 110 may receive the first information by receiving a configuration indicating a probability of selecting the anchor cell and a probability of selecting a non-anchor cell in the set of non-anchor cells. In these embodiments, the terminal device 110 may select the target cell by: selecting the target cell from the anchor cell and the set of non-anchor cells based on the probability of selecting the anchor cell and the probability of selecting the non-anchor cell.

In some embodiments, the terminal device 110 may receive the first information by receiving a configuration indicating a weight of the anchor cell and a weight of a non-anchor cell in the set of non-anchor cells. In these embodiments, the terminal device 110 may select the target cell by: selecting the target cell from the anchor cell and the set of non-anchor cells based on an identity of the terminal device and the weight of the anchor cell and the weight of the non-anchor cell in the set of non-anchor cells.

In some embodiments, the terminal device 110 may receive the first information by receiving a set of criteria for the selection, criteria in the set of criteria being associated with radio conditions of the anchor cell for the terminal device. In these embodiments, the terminal device 110 may select the target cell by: determining a radio condition of the anchor cell for the terminal device by a signal quality measurement for the anchor cell; and selecting the target cell based on a criterion associated with the radio condition.

In some embodiments, the terminal device 110 may receive the first information by receiving a set of criteria for the selection, criteria in the set of criteria being associated with SSBs from the anchor cell. In these embodiments, the terminal device 110 may select the target cell by: determining a set of SSBs from the anchor cell that have signal quality above threshold signal quality; and selecting the target cell based on a criterion associated with the set of SSBs in the set of criteria.

In some embodiments, the set of criteria may be based on at least one of the following: a probability of selecting the anchor cell; a probability of selecting a non-anchor cell in the set of non-anchor cells; a weight of the anchor cell; a weight of a non-anchor cell in the set of non-anchor cells; a RIP feature; or threshold quality for cells.

In some embodiments, the terminal device 110 may receive the first information by receiving a configuration indicating first threshold quality for cells, In these embodiments, the terminal device 110 may select the target cell by: determining cell quality of the anchor cell and cell quality of each non-anchor cell in the set of non-anchor cells; and determining the target cell from the anchor cell and the set of non-anchor cells based on the first threshold quality and the cell quality of the anchor cell and the set of non-anchor cells. In some embodiments, the terminal device 110 may further receive, as the first information, a configuration indicating a criterion for the selection. In these embodiments, the terminal device 110 may determine the target cell by: determining a set of cells having cell quality above the first threshold quality; and selecting the target cell from the set of cells based on the criterion.

In some embodiments, the terminal device 110 may receive the first information by receiving a configuration indicating second threshold quality for non-anchor cells. In these embodiments, the terminal device 110 may select the target cell by: determining cell quality of each non-anchor cell in the set of non-anchor cells; and determining the target cell from the set of non-anchor cells based on the second threshold quality and the cell quality of the set of non-anchor cells.

In some embodiments, the terminal device 110 may determine the cell quality of a non-anchor cell by: receiving a configuration indicating a set of offsets associated with the set of non-anchor cells; and determining the cell quality of the non-anchor cell based on an offset associated with the non-anchor cell in the set of offsets and the cell quality of the anchor cell.

In some embodiments, the terminal device 110 may determine the cell quality of a non-anchor cell by: receiving a configuration indicating a mapping between the set of non-anchor cells and SSBs of the anchor cell; determining a set of beam measurement results of a set of SSBs corresponding to the non-anchor cell based on the mapping; and determining the cell quality of the non-anchor cell based on the set of beam measurement results.

In some embodiments, if a highest beam measurement result in the set of beam measurement results is below a threshold measurement result or the threshold measurement result is not configured, the terminal device 110 may determine the cell quality of the non-anchor cell based on the highest beam measurement result. In some embodiments, if a highest beam measurement result in the set of beam measurement results is above the threshold measurement result, the terminal device 110 may determine the cell quality of the non-anchor cell based on an average value of the set of beam measurement results.

In some embodiments, the terminal device 110 may receive the first information by receiving a configuration indicating a mapping between the set of non-anchor cells and indexes of SSBs of the anchor cell. In these embodiments, the terminal device 110 may select the target cell by: determining an SSB of the anchor cell having a highest beam measurement result; and determining, as the target cell, a non-anchor cell associated with the SSB based on the mapping. In some embodiments, the terminal device 110 may determine the non-anchor cell by: determining a plurality of non-anchor cells associated with the index of the SSB; and selecting one of the plurality of non-anchor cells based on a configured criterion.

In some embodiments, the terminal device 110 may receive the first information by receiving an indication indicating that a RIP feature is used as a criterion for the selection and is applicable for the random access procedure. In these embodiments, the terminal device 110 may identify a cell having a RACH resource configured with the RIP feature. If a single cell is identified, the terminal device 110 may select the single cell as the target cell. If a plurality of cells are identified, the terminal device 110 may select the target cell from the plurality of cells based on a configured criterion.

In some embodiments, the terminal device 110 may receive the first information by receiving an indication indicating that a RIP feature is used as a criterion for the selection and is applicable for the random access procedure. In these embodiments, the terminal device 110 may determine a set of cells having quality higher than a configured threshold quality. If a RACH resource for a single cell in the set of cells is configured with the RIP feature, the terminal device 110 may select the single cell as the target cell. If RACH resources for a plurality of cells in the set of cells are configured with the RIP feature, the terminal device 110 may select the target cell from the plurality of cells based on a configured criterion.

In some embodiments, the second information may comprise cell status information indicating availability of a non-anchor cell in the set of non-anchor cells for random access. In some embodiments, the cell status information may comprise a bitmap indicating the availability of the non-anchor cell in the set of non-anchor cells. In some embodiments, the second information may further comprise an indication indicating whether the non-anchor cell transmits no SIB or no SIB and SSB.

In some embodiments, the terminal device 110 may receive the first information by: receiving a RRC message comprising information of a non-anchor cell as the target cell. In some embodiments, if a change of a cell quality measurement result is above a threshold change or a cell reselection occurs, the terminal device 110 may consider the information of the non-anchor cell to be invalid.

In some embodiments, the terminal device 110 may receive the first information by: receiving DCI comprising information of a non-anchor cell as the target cell.

In some embodiments, the terminal device 110 may receive a configuration indicating a backoff offset. If the RA procedure is unsuccessfully completed, the terminal device 110 may determine a further cell for random access based on the target cell and the backoff offset. In some embodiments, the terminal device 110 may further receive a configuration indicating valid information of the backoff offset, and apply the backoff offset based on the valid information.

At block 340, the terminal device 110 initiates a RA procedure to the target cell.

In some embodiments where DCI comprising information of a non-anchor cell as the target cell is received, the DCI may further comprise an index of SSB. The terminal device 110 may determine, based on the index of SSB, an occasion for initiating the RA procedure in the non-anchor cell. In some embodiments, the terminal device 110 may determine the occasion by: receiving a mapping between SSBs of the anchor cell and occasions for random access to the non-anchor cell; and determining the occasion based on the mapping and the index of SSB.

In some embodiments, the terminal device 110 may receive a mapping between SSBs of the anchor cell and occasions for RA to a non-anchor cell in the set of non-anchor cells. If a SSB of the anchor cell is selected, the terminal device 110 may determine an occasion for initiating the RA procedure in the non-anchor cell based on the mapping and the selected SSB.

With the method 300, an RA procedure related to a NES cell may be specified.

FIG. 4 illustrates an example method 400 of communication implemented at a network device in accordance with some embodiments of the present disclosure. For example, the method 400 may be performed at the network device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the network device 120 transmits first information for selection of a target cell from at least one of an anchor cell or a set of non-anchor cells. The set of non-anchor cells supports NES.

In some embodiments, the network device 120 may transmit the first information by: transmitting a configuration indicating a probability of selecting the anchor cell. In some embodiments, the network device 120 may transmit the first information by: transmitting a configuration indicating a probability of selecting the anchor cell and a probability of selecting a non-anchor cell in the set of non-anchor cells.

In some embodiments, the network device 120 may transmit the first information by: transmitting a configuration indicating a weight of the anchor cell and a weight of a non-anchor cell in the set of non-anchor cells.

In some embodiments, the network device 120 may transmit the first information by: transmitting a set of criteria for the selection, criteria in the set of criteria being associated with radio conditions of the anchor cell for the terminal device. In some embodiments, the network device 120 may transmit the first information by: transmitting a set of criteria for the selection, criteria in the set of criteria being associated with SSBs from the anchor cell. In some embodiments, the set of criteria may be based on at least one of the following: a probability of selecting the anchor cell; a probability of selecting a non-anchor cell in the set of non-anchor cells; a weight of the anchor cell; a weight of a non-anchor cell in the set of non-anchor cells; a RIP feature; or threshold quality for cells.

In some embodiments, the network device 120 may transmit the first information by: transmitting a configuration indicating first threshold quality for cells. In some embodiments, the network device 120 may transmit the first information by: transmitting a configuration indicating the first threshold quality for cells and a criterion for the selection. In some embodiments, the network device 120 may transmit the first information by: transmitting a configuration indicating second threshold quality for non-anchor cells.

In some embodiments, the network device 120 may transmit the first information by: transmitting a configuration indicating a mapping between the set of non-anchor cells and indexes of SSBs of the anchor cell.

In some embodiments, the network device 120 may transmit the first information by: transmitting an indication indicating that a RIP feature is used as a criterion for the selection and is applicable for the random access procedure.

In some embodiments, the network device 120 may further transmit a configuration indicating a set of offsets associated with the set of non-anchor cells.

In some embodiments, the network device 120 may transmit the first information by: transmitting an RRC message comprising information of a non-anchor cell as the target cell.

In some embodiments, the network device 120 may transmit the first information by: transmitting DCI comprising information of a non-anchor cell as the target cell.

At block 420, the network device 120 transmits second information for access to the set of non-anchor cells. The first and second information are used for selection of the target cell for an RA procedure.

In some embodiments, the second information may comprise cell status information indicating availability of a non-anchor cell in the set of non-anchor cells for random access.

In some embodiments, the cell status information may comprise a bitmap indicating the availability of the non-anchor cell in the set of non-anchor cells.

In some embodiments, the second information may further comprise an indication indicating whether the non-anchor cell transmits no SIB or no SIB and SSB.

In some embodiments where DCI comprising information of a non-anchor cell as the target cell is transmitted, the DCI may further comprise an index of SSB for determination of an occasion for initiating the random access procedure in the non-anchor cell. In some embodiments, the network device 120 may further transmit a mapping between SSBs of the anchor cell and occasions for random access to the non-anchor cell.

In some embodiments, the network device 120 may transmit a configuration indicating a backoff offset. In some embodiments, the network device 120 may further transmit a configuration indicating valid information of the backoff offset.

With the method 400, an RA procedure related to an NES cell may be facilitated.

### Example Implementation of Device and Apparatus

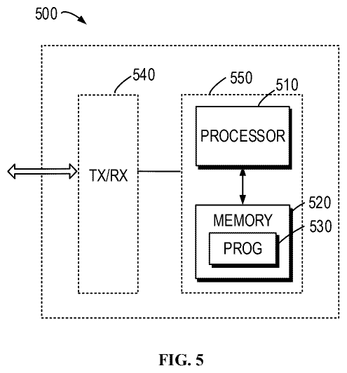

FIG. 5 is a simplified block diagram of a device 500 that is suitable for implementing embodiments of the present disclosure. The device 500 can be considered as a further example implementation of the terminal device 110 or the network device 120 as shown in FIG. 1. Accordingly, the device 500 can be implemented at or as at least a part of the terminal device 110 or the network device 120.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, Sl/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1 to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises a circuitry configured to: receive first information for selection of a target cell from at least one of an anchor cell or a set of non-anchor cells, the set of non-anchor cells supporting network energy saving; receive second information for access to the set of non-anchor cells; select, based on the first information and the second information, the target cell from the at least one of the anchor cell or the set of non-anchor cells; and initiate a random access procedure to the target cell.

In some embodiments, a network device comprises a circuitry configured to: transmit first information for selection of a target cell from at least one of an anchor cell or a set of non-anchor cells, the set of non-anchor cells supporting network energy saving; and transmit second information for access to the set of non-anchor cells, the first and second information being used for selection of the target cell for a random access procedure.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: receive first information for selection of a target cell from at least one of an anchor cell or a set of non-anchor cells, the set of non-anchor cells supporting network energy saving; receive second information for access to the set of non-anchor cells; select, based on the first information and the second information, the target cell from the at least one of the anchor cell or the set of non-anchor cells; and initiate a random access procedure to the target cell.

In some embodiments, the terminal device is caused to receive the first information by receiving a configuration indicating a probability of selecting the anchor cell, and the terminal device is caused to select the target cell by: determining, based on the probability of selecting the anchor cell and a number of available non-anchor cells, a probability of selecting a non-anchor cell in the set of non-anchor cells; and selecting the target cell from the anchor cell and the set of non-anchor cells based on the probability of selecting the anchor cell and the probability of selecting the non-anchor cell.

In some embodiments, the terminal device is caused to receive the first information by receiving a configuration indicating a probability of selecting the anchor cell and a probability of selecting a non-anchor cell in the set of non-anchor cells, and the terminal device is caused to select the target cell by: selecting the target cell from the anchor cell and the set of non-anchor cells based on the probability of selecting the anchor cell and the probability of selecting the non-anchor cell.

In some embodiments, the terminal device is caused to receive the first information by receiving a configuration indicating a weight of the anchor cell and a weight of a non-anchor cell in the set of non-anchor cells, and the terminal device is caused to select the target cell by: selecting the target cell from the anchor cell and the set of non-anchor cells based on an identity of the terminal device and the weight of the anchor cell and the weight of the non-anchor cell in the set of non-anchor cells.

In some embodiments, the terminal device is caused to receive the first information by receiving a set of criteria for the selection, criteria in the set of criteria being associated with radio conditions of the anchor cell for the terminal device, and the terminal device is caused to select the target cell by: determining a radio condition of the anchor cell for the terminal device by a signal quality measurement for the anchor cell; and selecting the target cell based on a criterion associated with the radio condition.

In some embodiments, the terminal device is caused to receive the first information by receiving a set of criteria for the selection, criteria in the set of criteria being associated with SSBs from the anchor cell, and wherein the terminal device is caused to select the target cell by: determining a set of SSBs from the anchor cell that have signal quality above threshold signal quality; and selecting the target cell based on a criterion associated with the set of SSBs in the set of criteria.

In some embodiments, the set of criteria is based on at least one of the following: a probability of selecting the anchor cell; a probability of selecting a non-anchor cell in the set of non-anchor cells; a weight of the anchor cell; a weight of a non-anchor cell in the set of non-anchor cells; a RIP feature; or threshold quality for cells.

In some embodiments, the terminal device is caused to receive the first information by receiving a configuration indicating first threshold quality for cells, and the terminal device is caused to select the target cell by: determining cell quality of the anchor cell and cell quality of each non-anchor cell in the set of non-anchor cells; and determining the target cell from the anchor cell and the set of non-anchor cells based on the first threshold quality and the cell quality of the anchor cell and the set of non-anchor cells.

In some embodiments, the terminal device is further caused to receive the first information by receiving a configuration indicating a criterion for the selection, and the terminal device is caused to determine the target cell by: determining a set of cells having cell quality above the first threshold quality; and selecting the target cell from the set of cells based on the criterion.

In some embodiments, the terminal device is caused to receive the first information by receiving a configuration indicating second threshold quality for non-anchor cells, and the terminal device is caused to select the target cell by: determining cell quality of each non-anchor cell in the set of non-anchor cells; and determining the target cell from the set of non-anchor cells based on the second threshold quality and the cell quality of the set of non-anchor cells.

In some embodiments, the terminal device is caused to determine the cell quality of a non-anchor cell by: receiving a configuration indicating a set of offsets associated with the set of non-anchor cells; and determining the cell quality of the non-anchor cell based on an offset associated with the non-anchor cell in the set of offsets and the cell quality of the anchor cell.

In some embodiments, the terminal device is caused to determine the cell quality of a non-anchor cell by: receiving a configuration indicating a mapping between the set of non-anchor cells and SSBs of the anchor cell; determining a set of beam measurement results of a set of SSBs corresponding to the non-anchor cell based on the mapping; and determining the cell quality of the non-anchor cell based on the set of beam measurement results.

In some embodiments, the terminal device is caused to determine the cell quality of a non-anchor cell by: in accordance with a determination that a highest beam measurement result in the set of beam measurement results is below a threshold measurement result or the threshold measurement result is not configured, determining the cell quality of the non-anchor cell based on the highest beam measurement result; or in accordance with a determination that a highest beam measurement result in the set of beam measurement results is above the threshold measurement result, determining the cell quality of the non-anchor cell based on an average value of the set of beam measurement results.

In some embodiments, the terminal device is caused to receive the first information by receiving a configuration indicating a mapping between the set of non-anchor cells and indexes of SSBs of the anchor cell, and the terminal device is caused to select the target cell by: determining an SSB of the anchor cell having a highest beam measurement result; and determining, as the target cell, a non-anchor cell associated with the SSB based on the mapping.

In some embodiments, the terminal device is caused to determine the non-anchor cell by: determining a plurality of non-anchor cells associated with the index of the SSB; and selecting one of the plurality of non-anchor cells based on a configured criterion.

In some embodiments, the terminal device is caused to receive the first information by receiving an indication indicating that a RIP feature is used as a criterion for the selection and is applicable for the random access procedure, and the terminal device is caused to select the target cell by: identifying a cell having a RACH resource configured with the RIP feature; in accordance with a determination that a single cell is identified, selecting the single cell as the target cell; and in accordance with a determination that a plurality of cells are identified, selecting the target cell from the plurality of cells based on a configured criterion.

In some embodiments, the terminal device is caused to receive the first information by receiving an indication indicating that a RIP feature is used as a criterion for the selection and is applicable for the random access procedure, and the terminal device is caused to select the target cell by: determining a set of cells having quality higher than a configured threshold quality; in accordance with a determination that a RACH resource for a single cell in the set of cells is configured with the RIP feature, selecting the single cell as the target cell; and in accordance with a determination that RACH resources for a plurality of cells in the set of cells are configured with the RIP feature, selecting the target cell from the plurality of cells based on a configured criterion.

In some embodiments, the second information comprises cell status information indicating availability of a non-anchor cell in the set of non-anchor cells for random access.

In some embodiments, the cell status information comprises a bitmap indicating the availability of the non-anchor cell in the set of non-anchor cells.

In some embodiments, the second information further comprises an indication indicating whether the non-anchor cell transmits no SIB or no SIB and SSB.

In some embodiments, the terminal device is caused to receive the first information by: receiving a radio resource control message comprising information of a non-anchor cell as the target cell. In some embodiments, the terminal device is further caused to: in accordance with a determination that a change of a cell quality measurement result is above a threshold change or a cell reselection occurs, considering the information of the non-anchor cell to be invalid.

In some embodiments, the terminal device is caused to receive the first information by: receiving downlink control information comprising information of a non-anchor cell as the target cell. In some embodiments, the downlink control information further comprises an index of SSB, and the terminal device is further caused to: determine, based on the index of SSB, an occasion for initiating the random access procedure in the non-anchor cell.

In some embodiments, the terminal device is caused to determine the occasion by: receiving a mapping between SSBs of the anchor cell and occasions for random access to the non-anchor cell; and determining the occasion based on the mapping and the index of SSB.

In some embodiments, the terminal device is further caused to: receive a mapping between SSBs of the anchor cell and occasions for random access to a non-anchor cell in the set of non-anchor cells, and in accordance with a determination that a SSB of the anchor cell is selected, determine an occasion for initiating the random access procedure in the non-anchor cell based on the mapping and the selected SSB.

In some embodiments, the terminal device is further caused to: receive a configuration indicating a backoff offset; and in accordance with a determination that the random access procedure is unsuccessfully completed, determine a further cell for random access based on the target cell and the backoff offset. In some embodiments, the terminal device is further caused to: receive a configuration indicating valid information of the backoff offset; and apply the backoff offset based on the valid information.

In another solution, a network device comprises a processor configured to cause the network device to: transmit first information for selection of a target cell from at least one of an anchor cell or a set of non-anchor cells, the set of non-anchor cells supporting network energy saving; and transmit second information for access to the set of non-anchor cells, the first and second information being used for selection of the target cell for a random access procedure.

In some embodiments, the network device is caused to transmit the first information by: transmitting a configuration indicating a probability of selecting the anchor cell; transmitting a configuration indicating a probability of selecting the anchor cell and a probability of selecting a non-anchor cell in the set of non-anchor cells; transmitting a configuration indicating a weight of the anchor cell and a weight of a non-anchor cell in the set of non-anchor cells; transmitting a set of criteria for the selection, criteria in the set of criteria being associated with radio conditions of the anchor cell for the terminal device; transmitting a set of criteria for the selection, criteria in the set of criteria being associated with SSBs from the anchor cell; transmitting a configuration indicating first threshold quality for cells; transmitting a configuration indicating the first threshold quality for cells and a criterion for the selection; transmitting a configuration indicating second threshold quality for non-anchor cells; transmitting a configuration indicating a mapping between the set of non-anchor cells and indexes of SSBs of the anchor cell; or transmitting an indication indicating that a RIP feature is used as a criterion for the selection and is applicable for the random access procedure.

In some embodiments, the set of criteria is based on at least one of the following: a probability of selecting the anchor cell; a probability of selecting a non-anchor cell in the set of non-anchor cells; a weight of the anchor cell; a weight of a non-anchor cell in the set of non-anchor cells; a RIP feature; or threshold quality for cells.

In some embodiments, the network device is further caused to: transmit a configuration indicating a set of offsets associated with the set of non-anchor cells.

In some embodiments, the second information comprises cell status information indicating availability of a non-anchor cell in the set of non-anchor cells for random access.

In some embodiments, the cell status information comprises a bitmap indicating the availability of the non-anchor cell in the set of non-anchor cells.

In some embodiments, the second information further comprises an indication indicating whether the non-anchor cell transmits no SIB or no SIB and SSB.

In some embodiments, the network device is caused to transmit the first information by: transmitting a radio resource control message comprising information of a non-anchor cell as the target cell.

In some embodiments, the network device is caused to transmit the first information by: transmitting downlink control information comprising information of a non-anchor cell as the target cell. In some embodiments, the downlink control information further comprises an index of SSB for determination of an occasion for initiating the random access procedure in the non-anchor cell. In some embodiments, the network device is further caused to: transmit a mapping between SSBs of the anchor cell and occasions for random access to the non-anchor cell.

In some embodiments, the network device is further caused to: transmit a configuration indicating a backoff offset. In some embodiments, the network device is further caused to: transmit a configuration indicating valid information of the backoff offset.

In another solution, a method of communication comprises: receiving, at a terminal device, first information for selection of a target cell from at least one of an anchor cell or a set of non-anchor cells, the set of non-anchor cells supporting network energy saving; receiving second information for access to the set of non-anchor cells; selecting, based on the first information and the second information, the target cell from the at least one of the anchor cell or the set of non-anchor cells; and initiating a random access procedure to the target cell.

In another solution, a method of communication comprises: transmitting, at a network device, first information for selection of a target cell from at least one of an anchor cell or a set of non-anchor cells, the set of non-anchor cells supporting network energy saving; and transmitting second information for access to the set of non-anchor cells, the first and second information being used for selection of the target cell for a random access procedure.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
a processor configured to cause the terminal device to:
receive first information for selection of a target cell from at least one of an anchor cell or a set of non-anchor cells, the set of non-anchor cells supporting network energy saving;
receive second information for access to the set of non-anchor cells;
select, based on the first information and the second information, the target cell from the at least one of the anchor cell or the set of non-anchor cells; and
initiate a random access procedure to the target cell.

2. The terminal device of claim 1, wherein the terminal device is caused to receive the first information by receiving a configuration indicating a probability of selecting the anchor cell, and wherein the terminal device is caused to select the target cell by:
determining, based on the probability of selecting the anchor cell and a number of available non-anchor cells, a probability of selecting a non-anchor cell in the set of non-anchor cells; and
selecting the target cell from the anchor cell and the set of non-anchor cells based on the probability of selecting the anchor cell and the probability of selecting the non-anchor cell.

3. The terminal device of claim 1, wherein the terminal device is caused to receive the first information by receiving a configuration indicating a probability of selecting the anchor cell and a probability of selecting a non-anchor cell in the set of non-anchor cells, and wherein the terminal device is caused to select the target cell by:
selecting the target cell from the anchor cell and the set of non-anchor cells based on the probability of selecting the anchor cell and the probability of selecting the non-anchor cell.

4. The terminal device of claim 1, wherein the terminal device is caused to receive the first information by receiving a configuration indicating a weight of the anchor cell and a weight of a non-anchor cell in the set of non-anchor cells, and wherein the terminal device is caused to select the target cell by:
selecting the target cell from the anchor cell and the set of non-anchor cells based on an identity of the terminal device and the weight of the anchor cell and the weight of the non-anchor cell in the set of non-anchor cells.

5. The terminal device of claim 1, wherein the terminal device is caused to receive the first information by receiving a set of criteria for the selection, criteria in the set of criteria being associated with radio conditions of the anchor cell for the terminal device, and wherein the terminal device is caused to select the target cell by:
determining a radio condition of the anchor cell for the terminal device by a signal quality measurement for the anchor cell; and
selecting the target cell based on a criterion associated with the radio condition.

6. The terminal device of claim 1, wherein the terminal device is caused to receive the first information by receiving a set of criteria for the selection, criteria in the set of criteria being associated with synchronization signal and physical broadcast channel blocks (SSBs) from the anchor cell, and wherein the terminal device is caused to select the target cell by:
determining a set of SSBs from the anchor cell that have signal quality above threshold signal quality; and
selecting the target cell based on a criterion associated with the set of SSBs in the set of criteria.

7. The terminal device of claim 5, wherein the set of criteria is based on at least one of the following:
a probability of selecting the anchor cell;
a probability of selecting a non-anchor cell in the set of non-anchor cells;
a weight of the anchor cell;
a weight of a non-anchor cell in the set of non-anchor cells;
a random access channel (RACH) indication partition (RIP) feature; or
threshold quality for cells.

8. The terminal device of claim 1, wherein the terminal device is caused to receive the first information by receiving a configuration indicating first threshold quality for cells, and wherein the terminal device is caused to select the target cell by:
determining cell quality of the anchor cell and cell quality of each non-anchor cell in the set of non-anchor cells; and
determining the target cell from the anchor cell and the set of non-anchor cells based on the first threshold quality and the cell quality of the anchor cell and the set of non-anchor cells.

9. The terminal device of claim 8, wherein the terminal device is further caused to receive the first information by receiving a configuration indicating a criterion for the selection, and wherein the terminal device is caused to determine the target cell by:
determining a set of cells having cell quality above the first threshold quality; and
selecting the target cell from the set of cells based on the criterion.

10. The terminal device of claim 1, wherein the terminal device is caused to receive the first information by receiving a configuration indicating second threshold quality for non-anchor cells, and wherein the terminal device is caused to select the target cell by:
determining cell quality of each non-anchor cell in the set of non-anchor cells; and
determining the target cell from the set of non-anchor cells based on the second threshold quality and the cell quality of the set of non-anchor cells.

11. The terminal device of claim 8, wherein the terminal device is caused to determine the cell quality of a non-anchor cell by:
receiving a configuration indicating a set of offsets associated with the set of non-anchor cells; and
determining the cell quality of the non-anchor cell based on an offset associated with the non-anchor cell in the set of offsets and the cell quality of the anchor cell.

12. The terminal device of claim 8, wherein the terminal device is caused to determine the cell quality of a non-anchor cell by:
receiving a configuration indicating a mapping between the set of non-anchor cells and synchronization signal and physical broadcast channel blocks (SSBs) of the anchor cell;
determining a set of beam measurement results of a set of SSBs corresponding to the non-anchor cell based on the mapping; and
determining the cell quality of the non-anchor cell based on the set of beam measurement results.

13. The terminal device of claim 12, wherein the terminal device is caused to determine the cell quality of the non-anchor cell by:
in accordance with a determination that a highest beam measurement result in the set of beam measurement results is below a threshold measurement result or the threshold measurement result is not configured, determining the cell quality of the non-anchor cell based on the highest beam measurement result; or
in accordance with a determination that a highest beam measurement result in the set of beam measurement results is above the threshold measurement result, determining the cell quality of the non-anchor cell based on an average value of the set of beam measurement results.

14. The terminal device of claim 1, wherein the terminal device is caused to receive the first information by receiving a configuration indicating a mapping between the set of non-anchor cells and indexes of synchronization signal and physical broadcast channel blocks (SSBs) of the anchor cell, and wherein the terminal device is caused to select the target cell by:
determining an SSB of the anchor cell having a highest beam measurement result; and
determining, as the target cell, a non-anchor cell associated with the SSB based on the mapping.

15. The terminal device of claim 14, wherein the terminal device is caused to determine the non-anchor cell by:
determining a plurality of non-anchor cells associated with the index of the SSB; and
selecting one of the plurality of non-anchor cells based on a configured criterion.

16. The terminal device of claim 1, wherein the terminal device is caused to receive the first information by receiving an indication indicating that a random access channel (RACH) indication partition (RIP) feature is used as a criterion for the selection and is applicable for the random access procedure, and wherein the terminal device is caused to select the target cell by:
identifying a cell having a RACH resource configured with the RIP feature;
in accordance with a determination that a single cell is identified, selecting the single cell as the target cell; and
in accordance with a determination that a plurality of cells are identified, selecting the target cell from the plurality of cells based on a configured criterion.

17. The terminal device of claim 1, wherein the terminal device is caused to receive the first information by receiving an indication indicating that a random access channel (RACH) indication partition (RIP) feature is used as a criterion for the selection and is applicable for the random access procedure, and wherein the terminal device is caused to select the target cell by:
determining a set of cells having quality higher than a configured threshold quality;
in accordance with a determination that a RACH resource for a single cell in the set of cells is configured with the RIP feature, selecting the single cell as the target cell; and
in accordance with a determination that RACH resources for a plurality of cells in the set of cells are configured with the RIP feature, selecting the target cell from the plurality of cells based on a configured criterion.

18. The terminal device of claim 1, wherein the terminal device is caused to receive the first information by:
receiving a radio resource control message comprising information of a non-anchor cell as the target cell.

19. The terminal device of claim 1, wherein the terminal device is further caused to:
receive a mapping between SSBs of the anchor cell and occasions for random access to a non-anchor cell in the set of non-anchor cells, and
in accordance with a determination that a SSB of the anchor cell is selected, determine an occasion for initiating the random access procedure in the non-anchor cell based on the mapping and the selected SSB.

20. A method of communication, comprising:
receiving, at a terminal device, first information for selection of a target cell from at least one of an anchor cell or a set of non-anchor cells, the set of non-anchor cells supporting network energy saving;
receiving second information for access to the set of non-anchor cells;
selecting, based on the first information and the second information, the target cell from the at least one of the anchor cell or the set of non-anchor cells; and
initiating a random access procedure to the target cell.
